(19) United States
(12) Patent Application Publication
(10) Pub. No.: US 2015/0062075 A1
(43) Pub. Date: Mar. 5, 2015

(54) CAPACITIVE INPUT DEVICE

(71) Applicant: ALPS ELECTRIC CO., LTD., Tokyo (JP)

(72) Inventor: Hiroshi Wakuda, Miyagi-Ken (JP)

(21) Appl. No.: 14/454,167

(22) Filed: Aug. 7, 2014

(30) Foreign Application Priority Data
Sep. 3, 2013 (JP) 2013-181813

(51) Int. Cl. G06F 3/044

(52) U.S. Cl. CPC G06F 3/044
USPC 345/174

(57) ABSTRACT

All electrodes, which are arranged on the surface of a substrate, are independent electrodes that are electrically insulated from each other. The electrodes are selected in order so as to be set to a drive electrode, and drive power having a rectangular wave is applied to the drive electrode. The electrodes, which are adjacent to the drive electrode, are set to detection electrodes. Since drive power is applied to a single drive electrode, an electric field generated from the drive electrode uniformly spreads out in each direction. Accordingly, even though an operation of a space gesture is performed, it is possible to detect the operation with high resolution.

### CLAIM OF PRIORITY

This application claims benefit of priority to Japanese Patent Application No. 2013-181813 filed on Sep. 3, 2013, which is hereby incorporated by reference in its entirety.

### BACKGROUND

1. Field of the Disclosure

The present disclosure relates to a capacitive input device that includes a plurality of electrodes and detects the approach of an operating body, such as a finger or the palm of a hand.

2. Description of the Related Art

Japanese Unexamined Patent Application Publication No. 2013-134698 discloses a capacitive input device.

A plurality of first detection electrodes, which are continuous in an X direction, and a plurality of second detection electrodes, which are continuous in a Y direction, are provided in this input device so as to be insulated from each other, and the first and second detection electrodes are capacitively-coupled to each other. The capacitance of the plurality of first detection electrodes and the capacitance of the plurality of second detection electrodes are sequentially measured at the time of driving. It is possible to detect the touch point of a finger by comparing capacitance between the detection electrodes, which is obtained when the finger touches the detection electrodes, with capacitance between the detection electrodes that is obtained when the finger does not touch the detection electrodes.

The capacitive input device disclosed in Japanese Unexamined Patent Application Publication No. 2013-134698 is a touch panel, and is to detect the position of a finger that comes into contact with the surface of the panel.

Meanwhile, an input device, which can detect the coordinates of the position where a finger or the palm of a hand approaches, that is, a so-called space gesture when the finger or the palm of the hand approaches a position apart from the surface of an input device to some extent, has been required in recent years. In the detection of this space gesture, it is necessary to detect a change in capacitance between the respective electrodes with high resolution.

However, since the plurality of detection electrodes are continuous and extend in the X direction and the Y direction in the input device in the related art disclosed in Japanese Unexamined Patent Application Publication No. 2013-134698 or the like, an electric field, which is generated around the detection electrodes when drive power is applied to the detection electrodes, extends long and thin in the continuous direction of the detection electrodes. For this reason, it is difficult to detect the position in a space gesture where a finger or the palm of a hand approaches with high resolution. In particular, it is difficult to individually and accurately detect the approach of a plurality of fingers.

### SUMMARY

A capacitive input device comprises a plurality of electrodes provided on a substrate, and drive power is applied to a selected electrode, and a detection output is obtained from any electrode. All the electrodes are independent electrodes that are insulated from each other and are capacitively-coupled to each other. The capacitive input device includes a drive controller configured to apply drive power to a drive electrode selected from the independent electrodes and obtains detection outputs from the plurality of electrodes adjacent to the drive electrode.

### BRIEF DESCRIPTION OF THE DRAWINGS

FIG. 1 is a plan view showing the disposition of electrodes of a capacitive input device according to an embodiment of the invention;

FIG. 2 is an enlarged view of the cross-section of the input device shown in FIG. 1 taken along line II;

FIG. 3 is a view illustrating an electric field generated from a drive electrode;

FIG. 4 is a partial plan view showing the disposition of the drive electrode and detection electrodes;

FIG. 5 is a partial plan view showing the disposition of the drive electrode and detection electrodes when a selected drive electrode is moved;

FIG. 6 is a partial plan view showing the disposition of the drive electrode and detection electrodes when a selected drive electrode is moved;

FIG. 7 is a view illustrating a method of obtaining the center position of a finger, which has approached, by a quadratic interpolation method;

FIG. 8 is a view illustrating an image pattern that detects the approach of two fingers;

FIG. 9 is a view illustrating a method of obtaining interpolation-detection outputs of other electrodes on the basis of detection outputs that are obtained from a limited number of electrodes;

FIG. 10 is a view illustrating a method of obtaining interpolation-detection outputs of other electrodes on the basis of detection outputs that are obtained from a limited number of electrodes;

FIG. 11 is a view illustrating a method of obtaining interpolation-detection outputs of other electrodes on the basis of detection outputs that are obtained from a limited number of electrodes; and

FIG. 12 is an enlarged plan view showing a modification of the shape of electrodes.

### DESCRIPTION OF THE EXEMPLARY EMBODIMENTS

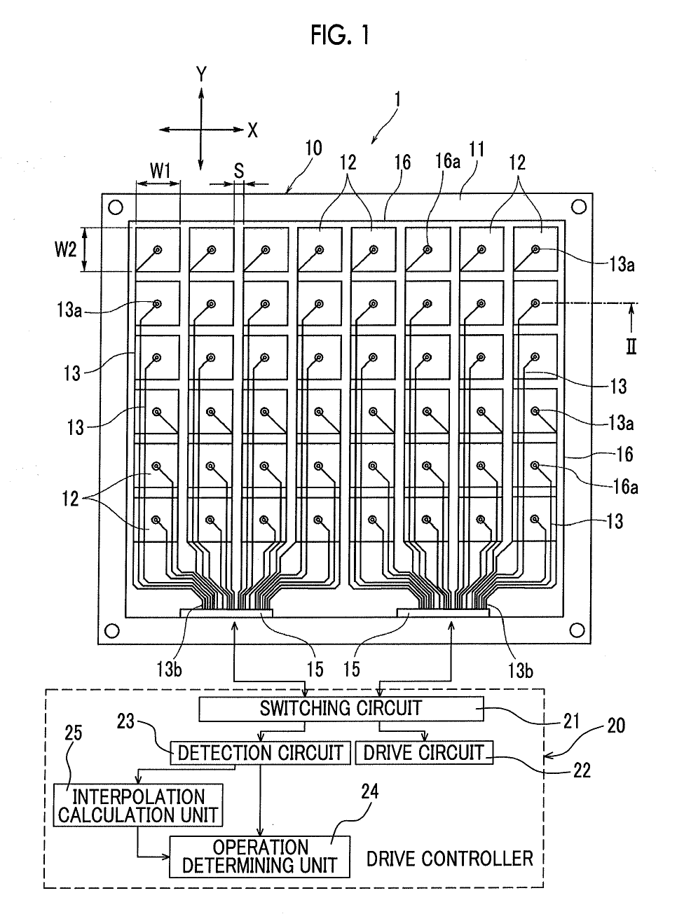

A capacitive input device 1 according to an embodiment of the invention shown in FIG. 1 includes a detection panel 10 and a drive controller 20.

The detection panel 10 includes a substrate 11. A plurality of electrodes 12 are provided on a surface 11a of the substrate 11. As shown in FIG. 1, the electrodes 12, which are present in a detection area, are independent electrodes that are electrically insulated from each other. The electrodes 12 are regularly disposed at a constant pitch in an X direction that is a first direction and are regularly disposed at a constant pitch in a Y direction that is a second direction.

As shown in FIG. 1, each electrode 12 has a quadrangular shape, more specifically, a square shape. The widths W1 and W2 of each electrode 12 are about 10 mm, and an interval S between the adjacent electrodes 12 is about 2 mm.

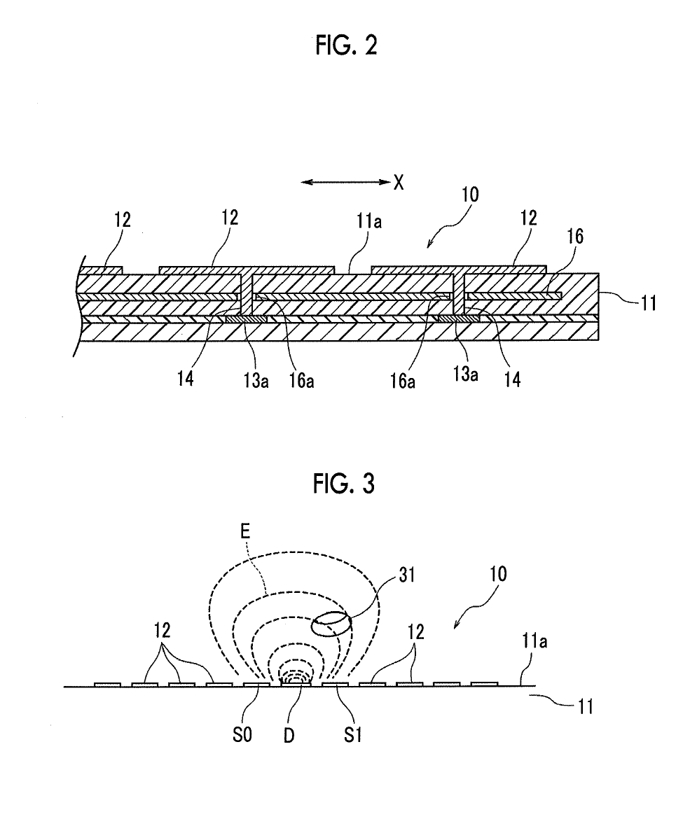

As shown in a cross-sectional view of FIG. 2, the substrate 11 is a multilayer substrate. A plurality of wiring layers 13 are embedded in a lower layer of the substrate 11. As shown in FIG. 1, tip end portions 13a of the respective wiring layers 13 are individually connected to the respective electrodes 12 through connection layers 14 that are formed in the substrate 11. The connection layers 14, which are connected to the electrodes 12, pass through a portion of the substrate 11 below the plurality of other electrodes 12, and base end portions 13b of the wiring layers 13 are connected to connectors 15 that are positioned at a lower edge portion of the substrate 11 as shown in FIG. 1.

As shown in FIG. 2, a shield layer 16 is embedded in an upper layer of the substrate 11. Holes 16a are formed at a plurality of positions of the shield layer 16, and the connection layers 14 pass through the holes 16a. Since the shield layer 16 is positioned between the electrodes 12 and the wiring layers 13 and is set to a ground potential, capacitance is not substantially formed between a finger, the palm of a hand of a human, or the like that approaches the surface 11a of the substrate 11 and the wiring layers 13. Accordingly, the wiring layers 13 do not cause noise to be generated in a detection output.

The detection panel 10 is disposed on operation panels of various electronic devices, and the surfaces of the electrodes 12 are covered with a non-conductive cover layer when the detection panel 10 is used. Further, when a display panel such as a color liquid crystal panel is disposed on the back of the detection panel 10, the entire detection panel 10 is made of a translucent material so that a user can visually check contents displayed on the display panel through the detection panel 10.

The drive controller 20 shown in FIG. 1 is mounted on a circuit board included in the detection panel 10, and includes a CPU, a memory, and the like. In FIG. 1, a plurality of functional circuits and functional units, which are provided in the drive controller 20, are denoted by reference numerals for each block, but these functional units are executed on the basis of software, which is stored in the memory, by the CPU.

A switching circuit 21 is provided in the drive controller 20. All the wiring layers 13 of the detection panel 10, which are individually connected to the respective electrodes 12, are connected to the switching circuit 21 through the connectors 15.

A drive circuit 22 and a detection circuit 23 are provided in the drive controller 20. The drive circuit 22 is connected to the respective independent electrodes 12 in order by being switched by the switching circuit 21.

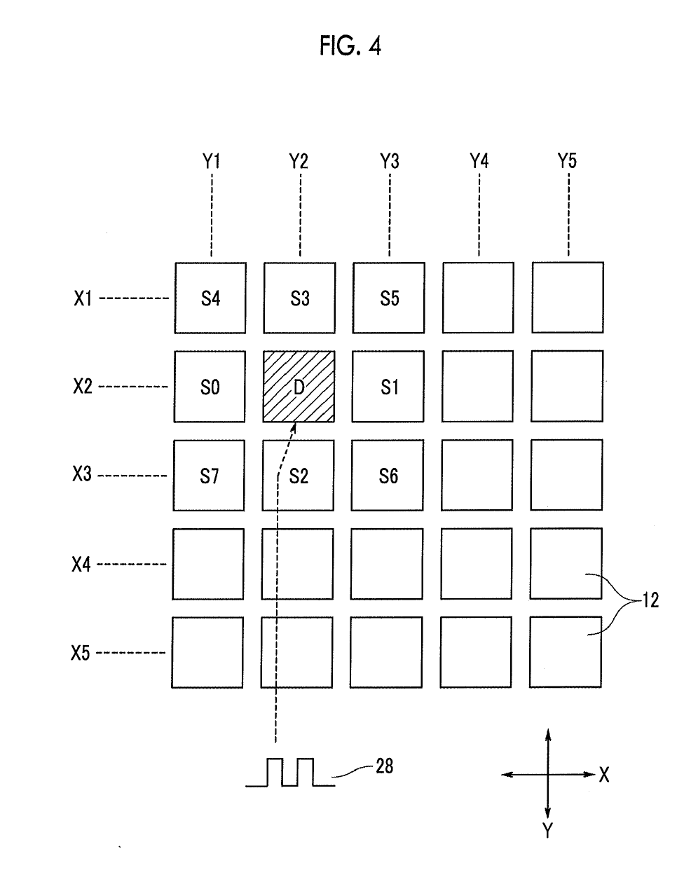

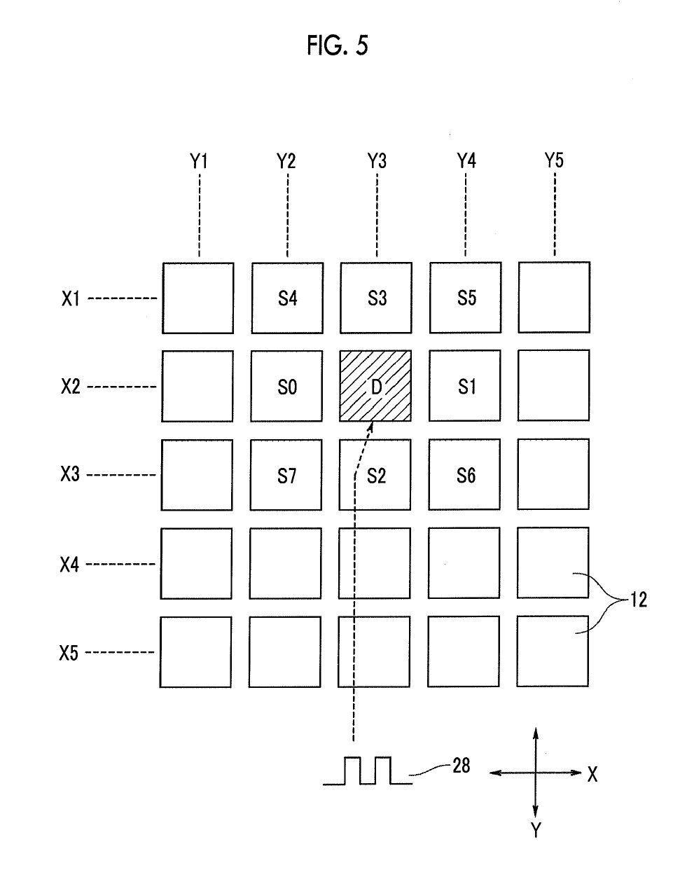

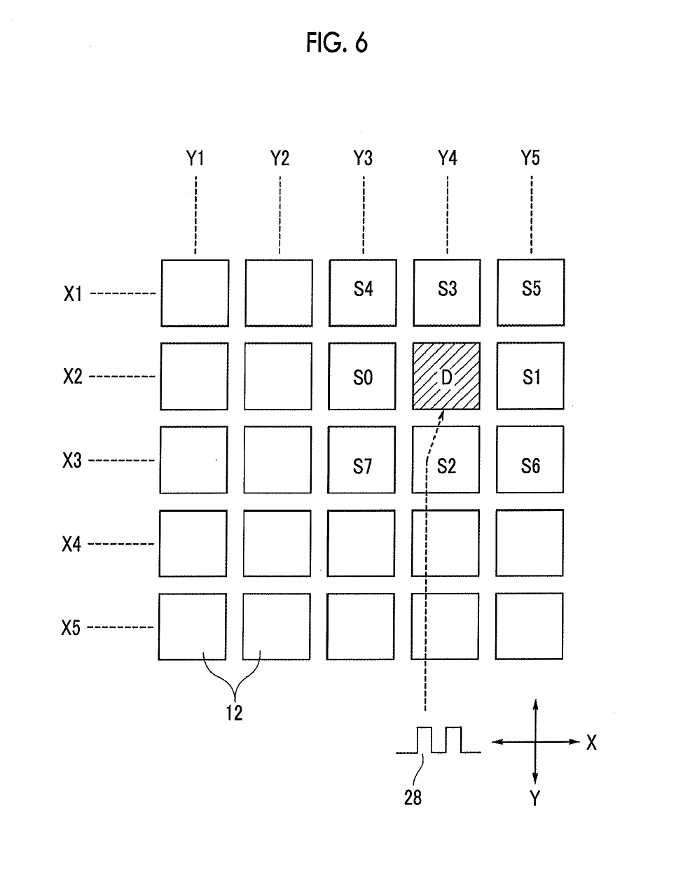

In FIGS. 4 to 6, rows of the electrodes 12 that are lined up at a constant pitch in the first direction (X direction) are denoted by X1, X2, X3, . . . and columns of the electrodes 12 that are lined up at a constant pitch in the second direction (Y direction) are denoted by Y1, Y2, Y3, . . . . In FIG. 4, the electrode 12, which is positioned at an intersection between the column Y2 and the row X2, is selected, is connected to the drive circuit 22, and functions as a drive electrode D. In FIG. 5, the electrode 12, which is positioned at an intersection between the column Y3 and the row X2, is selected and is switched to the drive electrode D. In FIG. 6, the electrode 12, which is positioned at an intersection between the column Y4 and the row X2, is selected and is switched to the drive electrode D.

The detection circuit 23, which is provided in the drive controller 20, is connected to the electrodes 12, which are independent electrodes, in order by the switching circuit 21. As shown in FIGS. 4 to 6, two electrodes 12, which are disposed on both sides of the drive electrode D in the X direction (first direction) so as to be adjacent to the drive electrode D, are connected to the detection circuit 23 by the switching circuit 21 and function as detection electrodes S0 and S1 and two electrodes 12, which are disposed on both sides of the drive electrode D in the Y direction (second direction) so as to be adjacent to the drive electrode D, are connected to the detection circuit 23 by the switching circuit 21 and function as detection electrodes S2 and S3. Further, four electrodes, which are positioned between the X direction and the Y direction and are adjacent to the drive electrode D, are connected to the detection circuit 23 and function as detection electrodes S4, S5, S6, and S7.

These detection electrodes S0, S1, S2, S3, S4, S5, S6, and S7 are capacitively-coupled to the drive electrode D.

The detection circuit 23 includes a detection unit having eight channels, and the eight detection electrodes S0, S1, S2, S3, S4, S5, S6, and S7 surrounding the drive electrode D are simultaneously connected to the detection unit of the detection circuit 23. Alternatively, when the detection circuit 23 includes a detection unit having one channel, the eight detection electrodes S0, S1, S2, S3, S4, S5, S6, and S7 surrounding the drive electrode D may be switched in a short time by the switching circuit 21 so as to be connected to the detection circuit 23, which has one channel, in order.

As shown in FIGS. 4 to 6, a rectangular wave, which has a short width, of a predetermined voltage is repeated at a short interval, so that drive power 28 supplied to the drive electrode D from the drive circuit 22 is applied.

All the electrodes 12 are independent electrodes that are electrically insulated from each other. Accordingly, when the drive power 28 is applied to the drive electrode D, an electric field E generated by the drive electrode D is distributed from the drive electrode D, which serves as a generation spot, with substantially uniform strength in all directions in the X-Y plane as shown in FIG. 3 and the same strength plane where the same electric field strength can be observed is formed on the drive electrode D in a substantially spherical shape. Since it is possible to improve the resolution of a detection output of each electrode with respect to an operating body by this electric field distribution, it is possible to also accurately detect a so-called space gesture and it is also easy to detect a plurality of fingers.

Since the drive electrode D is capacitively-coupled to the detection electrodes S0, S1, S2, S3, S4, S5, S6, and S7 surrounding the drive electrode D, a current flows in the detection electrodes S0, S1, S2, S3, S4, S5, S6, and S7 at the timing of the rise and fall of the rectangular wave when the drive power 28 having a rectangular wave is applied to the drive electrode D. A current value at this time, that is, a detection output depends on the capacitance between the drive electrode and the detection electrodes. Since a difference in capacitance between adjacent electrodes is detected using a capacitive coupling method, detection is hardly affected by surrounding changes. Accordingly, resolution is improved.

FIG. 3 shows a state in which a finger 31, which is a conductive operating body substantially having a ground potential, has approached the surface 11a of the substrate 11 between the drive electrode D and the detection electrode S1. When the finger 31 substantially having a ground potential approaches the surface 11a of the substrate 11, the capacitance between the drive electrode D and the detection electrode S1 is substantially changed and the amount of current of a detection output flowing in the detection electrode S1 at the timing of the rise and fall of the rectangular wave of the drive power 28 is reduced. Since the capacitance between the drive electrode D and each of the other detection electrodes S0, S2, S3, S4, S5, S6, and S7 is also substantially changed according to a distance between the finger 31 and the surface 11a, the amount of current of a detection output is changed.

As shown in FIG. 1, an operation determining unit 24 is provided in the drive controller 20. A detection output, which is obtained from the detection circuit 23 connected to the respective detection electrodes S0, S1, S2, S3, S4, S5, S6, and S7, is sent to the operation determining unit 24. In the operation determining unit 24, the determination of the shape of the operating body approaching the surface 11a of the substrate 11, the calculation of the coordinates of the center of the operating body, and the like are performed from detection outputs that are obtained from the plurality of electrodes 12.

The electrode is selected in order so that the position of the electrode 12 used as the drive electrode D is moved to the next column one by one. After all the electrodes 12 present in the detection area are selected as the drive electrode D, detection outputs obtained from all the electrodes present in the detection area are individually and temporarily stored in a storage unit in the operation determining unit 24. The detection area mentioned here may be an area that includes all the electrodes 12 arranged on the surface 11a of the substrate 11 shown in FIG. 1, and may be a limited area that includes a part of the electrodes 12 arranged on the surface 11a.

When the electrode is selected in order so that the position of the electrode 12 used as the drive electrode D is moved to the next column one by one as shown in FIGS. 4 to 6, the same electrode 12 is selected as the detection electrode several times. For example, the electrode 12, which is positioned at an intersection between the column Y3 and the row X1, is selected as the detection electrode S5 in FIG. 4, is selected as the detection electrode S3 in FIG. 5, and is selected as the detection electrode S4 in FIG. 6. Time required for selecting all the electrodes 12, which are present in a predetermined detection area, as the drive electrode D is very short, and the position of the finger 31 or the like is not almost changed during the time. Further, when the same electrode 12 is sequentially selected as the detection electrodes S5, S3, and S4, an average of the respective detection outputs detected by the detection electrodes S5, S3, and S4 is used as a normal detection output and the determination of the operating body is performed using this normal detection output in the operation determining unit 24.

When the same electrode 12 is selected as the detection electrode several times, it is possible to accurately obtain the detection output of the electrode 12 by obtaining an average of the detection outputs at the time of the respective selections.

Meanwhile, the adjacent electrode 12 may not be selected as the drive electrode D in order and every other electrode 12 or every two electrodes 12 may be selected as the drive electrode D so that the number of times of the selection of the same electrode 12 as the detection electrode is reduced and, for example, the same electrode 12 is selected as the detection electrode only one time.

Further, when any one of the electrodes 12 is selected as the detection electrode, differences in a detection output between the plurality of detection electrodes selected at that time are obtained and output of these differences may be used as detection outputs. Furthermore, a detection output is estimated while the drive electrode D is assumed as a detection electrode, and a difference between the estimated detection output of the drive electrode and a detection output, which is actually obtained from the detection electrode, may be used as a detection output obtained from the detection electrode.

For example, in FIG. 4, the average of the detection outputs, which are obtained from the eight detection electrodes S0, S1, S2, S3, S4, S5, S6, and S7, is estimated as a detection output that is obtained when the drive electrode D is assumed as a detection electrode. Further, a difference between an actual detection output of the detection electrode S1 and the estimated detection output is used as a detection output that is obtained from the detection electrode S1. Likewise, a difference between a detection output of each of the other detection electrodes S0, S2, S3, S4, S5, S6, and S7 and the estimated detection output is used as a detection output that is obtained from each of the detection electrodes.

It is possible to cancel noise or temperature drift components and the like by obtaining a difference between the detection outputs as described above.

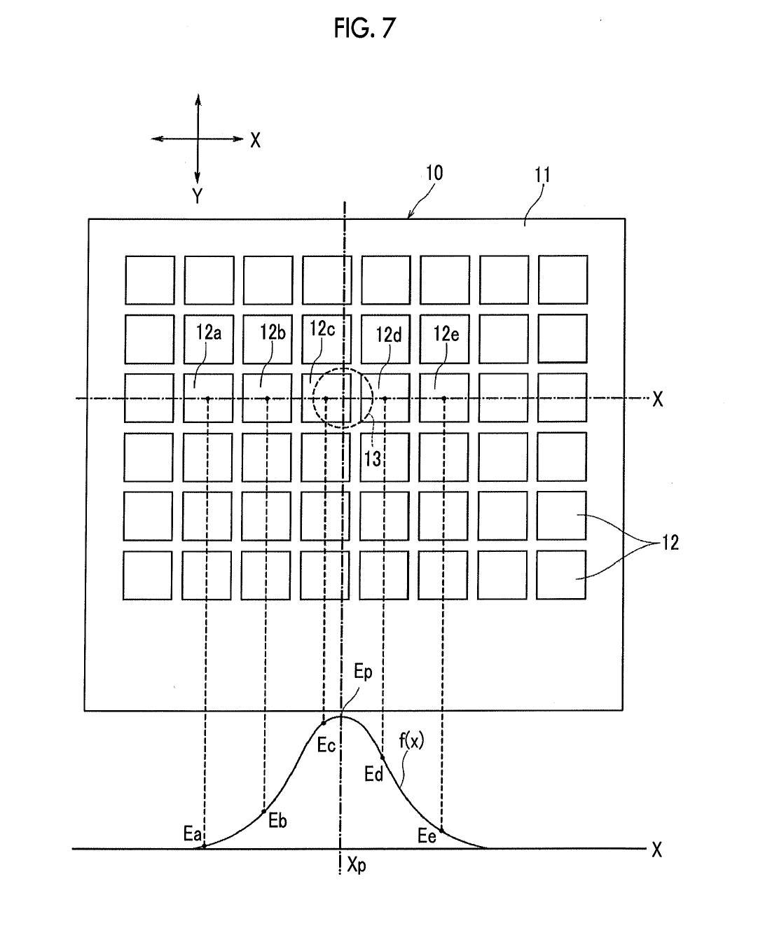

FIG. 7 illustrates a determining method when the finger 31 as an operating body approaches the surface 11a of the substrate 11.

Immediately after all the electrodes 12, which are present in the detection area, are selected as the drive electrode D, the detection outputs (normal detection outputs) obtained from all the electrodes 12, which are present in the detection area, are stored in the storage unit only for a short time. In FIG. 7, detection outputs (normal detection outputs) obtained from electrodes 12a, 12b, 12c, 12d, and 12e are denoted by Ea, Eb, Ec, Ed, and Ee. In the operation determining unit 24, a quadratic function f(x), which includes the detection outputs Ea, Eb, Ec, Ed, and Ee or in which distances from the detection outputs Ea, Eb, Ec, Ed, and Ee are shortest, is calculated by a quadratic interpolation method. An X-coordinate xp where an extreme value Ep of the quadratic function f(x) is obtained is calculated as an X-coordinate position of the center (centroid) of the finger 31.

Even in the Y direction, a coordinate of the extreme value is calculated by a quadratic interpolation method in the same manner as shown in FIG. 7. As a result, it is possible to obtain the coordinates of the center of the finger 31 that is approaching.

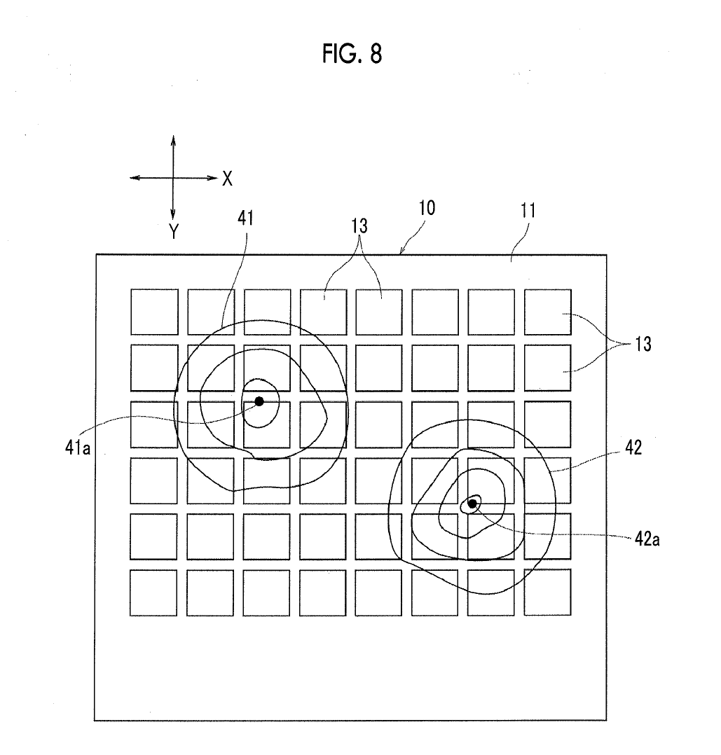

Further, it is possible to generate image data 41 and 42 of the operating body based on the detection output as shown in FIG. 8 by interpolating a difference in detection output between the adjacent electrodes 12 by a quadratic function or a linear function to give an output difference gradient and developing the difference in all directions in the X-Y plane. It is possible to determine whether or not the finger approaches or the palm of a hand approaches by the image data.

Furthermore, it is possible to calculate the centers 41a and 42a of the image data 41 and 42 by obtaining the centroids of the respective image data 41 and 42 or obtaining the coordinates of an extreme value by a quadratic interpolation method.

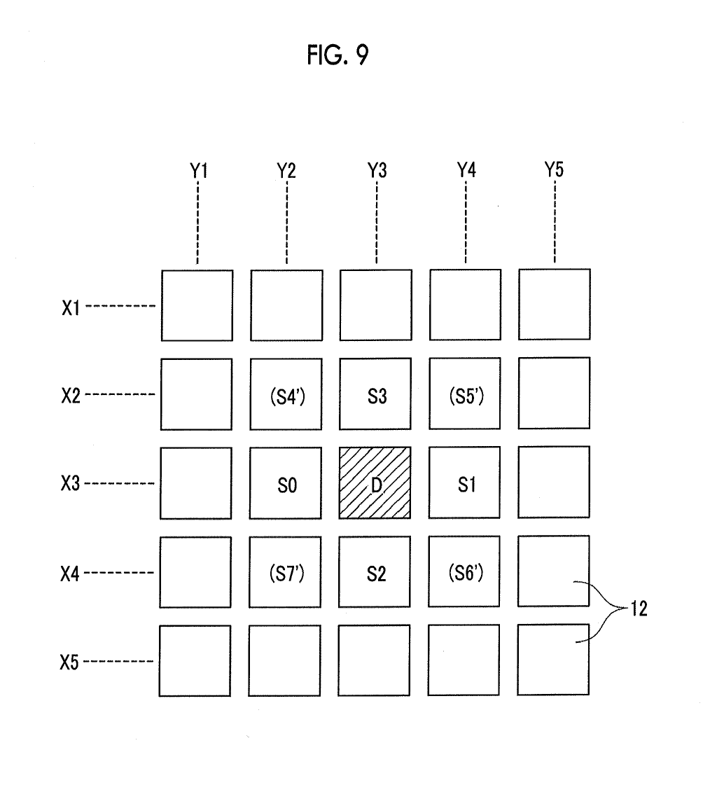

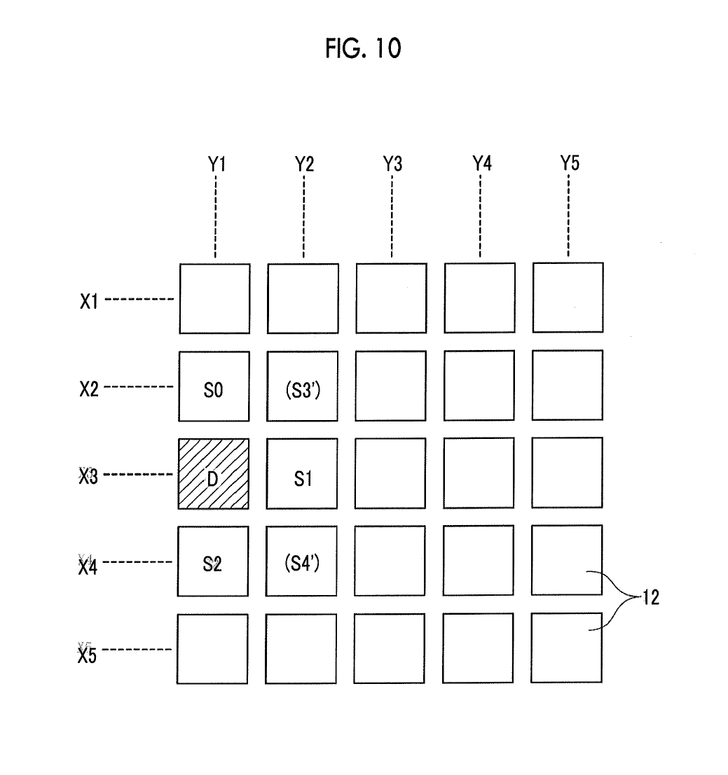

In the example shown in FIGS. 4 to 6, all the eight electrodes 12, which surround the electrode 12 selected as the drive electrode D, are connected to the detection circuit 23 and are selected as the detection electrodes S0, S1, S2, S3, S4, S5, S6, and S7. Accordingly, eight detection outputs are obtained. In contrast, FIGS. 9 to 11 show an example in which the detection circuit 23 includes only a detection unit having four channels, only four electrodes 12 between which the drive electrode D is interposed are selected as the detection electrodes, and only four detection outputs are obtained per drive electrode D.

In FIG. 9, the electrode 12, which is positioned at an intersection between the column Y3 and the row X3, is selected as the drive electrode D. Further, detection outputs are obtained from two detection electrodes S0 and S1 that are adjacent to the drive electrode D in the X direction and two detection electrodes S2 and S3 that are adjacent to the drive electrode D in the Y direction, that is, a total of four detection electrodes.

As shown in FIG. 1, an interpolation calculation unit 25 is provided in the drive controller 20. In the interpolation calculation unit 25, interpolation-detection outputs are calculated from four electrodes S4′, S5′, S6′, and S7′, which are adjacent to the drive electrode D, except for the four detection electrodes S0, S1, S2, and S3 as shown in FIG. 9. Interpolation calculation using a linear interpolation method is performed in the interpolation calculation unit 25.

In a method of the interpolation calculation, an assumed detection output Sd, which is obtained when the drive electrode D is assumed as a detection electrode, is obtained as an average that is obtained from the four detection electrodes S0, S1, S2, and S3.

Sd=ΣSn/4 (n=0,1,2,3)

An added output difference, which is obtained by adding an output difference between the assumed detection output Sd and the detection output of the detection electrode S3 to an output difference between the assumed detection output Sd and the detection output of the detection electrode S0, is obtained on the basis of the assumed detection output Sd. A value, which is obtained by adding the added output difference to the assumed detection output Sd, is set as an interpolation-detection output of the electrode S4′ that is positioned between the first direction (X direction) and the second direction (Y direction) and is adjacent to the drive electrode. The interpolation-detection outputs of the electrodes S4′, S5′, S6′, and S7′ are calculated by the following expressions.

S4′=Sd+(S0−Sd+S3−Sd)

S5′=Sd+(S1−Sd+S3−Sd)

S6′=Sd+(S1−Sd+S2−Sd)

S7′=Sd+(S0−Sd+S2−Sd)

FIG. 10 illustrates interpolation calculation when the electrode 12 positioned on the column Y1 is selected as the drive electrode D.

In this case, the assumed detection output Sd, which is obtained when the drive electrode D is assumed as a detection electrode, is obtained by “Sd=ΣSn/3 (n=0, 1, 2)”. Interpolation-detection outputs of electrodes S3′ and S4′, which are positioned between the first direction (X direction) and the second direction (Y direction) and are adjacent to the drive electrode, are obtained as follows.

S3′=Sd+(S0−Sd+S1−Sd)

S4′=Sd+(S1−Sd+S2−Sd)

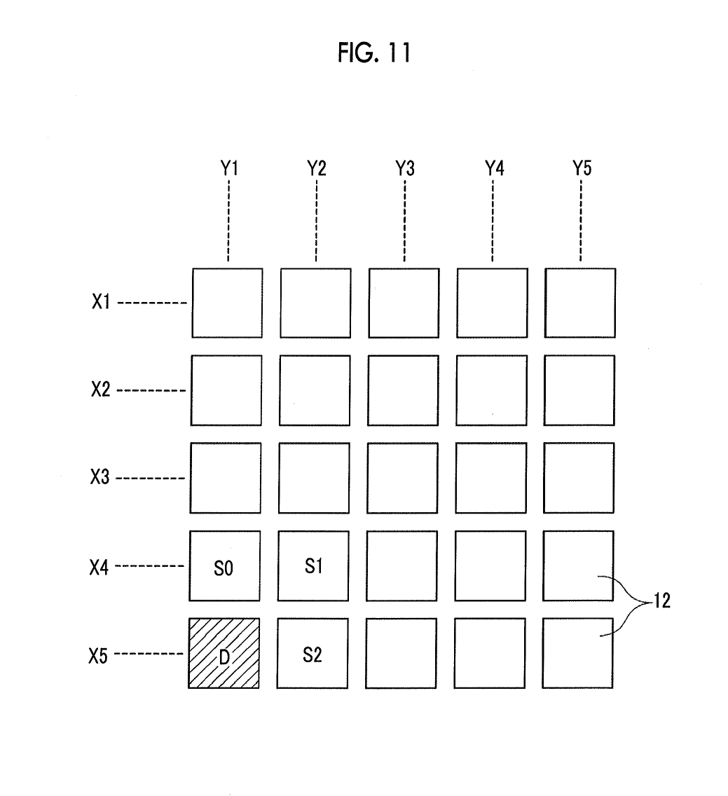

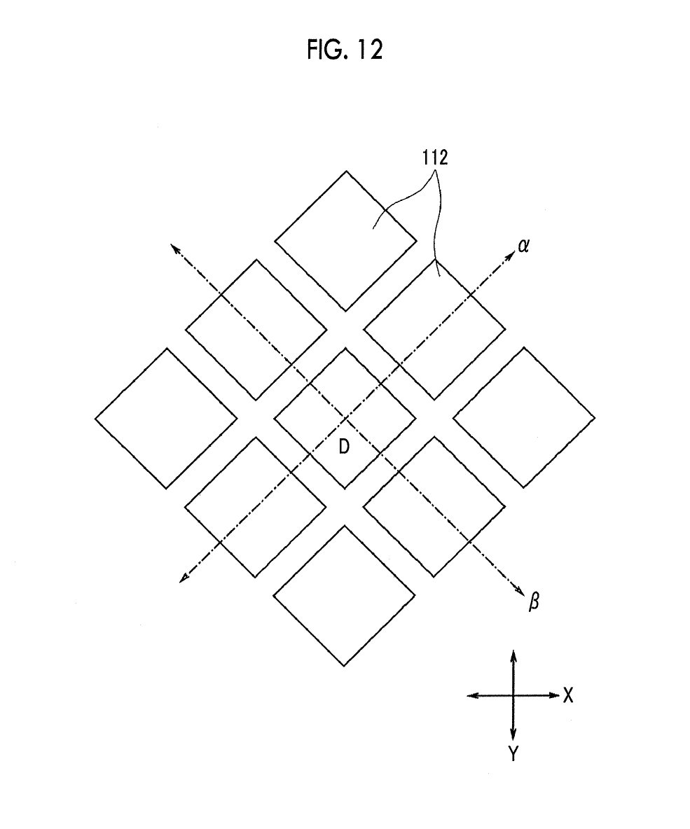

FIG. 11 is a view illustrating interpolation calculation when the drive electrode D is set to an electrode, which is positioned at a corner, among the electrodes 12 disposed in the detection area.

Here, three electrodes, which surround the drive electrode D, are set to detection electrodes S0, S1, and S2, and three detection outputs are obtained from the three detection electrodes. In this case, a detection output Sd of the electrode 12, which is positioned at an intersection between the column Y1 and the row X5 and is selected as the drive electrode D, is assumed as follows.

avg=(S0+S2)/2

Sd=avg−(S1−avg)

FIG. 12 shows a modification of electrodes provided in the input device 1.

Electrodes 112 shown in FIG. 12 are formed in a rhombic shape based on X-Y directions that are vertical and horizontal directions of the substrate 11. In this case, a first direction of the drive electrode D is a α direction, and a second direction thereof is a β direction. It is possible to obtain detection outputs in the same manner as the embodiment by replacing the X direction with the α direction and replacing the Y direction with the β direction in the embodiment.

It should be understood by those skilled in the art that various modifications, combinations, sub-combinations and alterations may occur depending on design requirements and other factors insofar as they are within the scope of the appended claims of the equivalents thereof.

What is claimed is:

1. A capacitive input device comprising:
a plurality of electrodes are provided on a substrate, drive power is applied to a selected electrode, and a detection output is obtained from any electrode,
wherein all the electrodes are independent electrodes that are insulated from each other and are capacitively-coupled to each other, and
a drive controller configured to apply drive power to a drive electrode selected from the independent electrodes and obtain detection outputs from the plurality of electrodes adjacent to the drive electrode.

2. The capacitive input device according to claim 1,
wherein in the drive controller, all electrodes in a predetermined area are sequentially selected as the drive electrode and coordinates of a center of an operating body, which has approached the substrate, are calculated on the basis of detection outputs obtained from the respective electrodes of the area except for the electrode that is selected as the drive electrode.

3. The capacitive input device according to claim 2,
wherein the coordinates of the center are calculated on the basis of the detection outputs, which are obtained from the respective electrodes, by a quadratic interpolation method.

4. The capacitive input device according to claim 1,
wherein the electrodes are selected as the drive electrode in order, so that a plurality of detection outputs are obtained from the same electrode, and
an average of the plurality of detection outputs is used as normal detection outputs obtained from the electrodes.

5. The capacitive input device according to claim 1,
wherein the independent electrodes are arranged in first and second directions, which are orthogonal to each other, along a surface of the substrate, and
in the drive controller, detection outputs are obtained from electrodes that are adjacent to the selected independent electrode in the first and second directions, and interpolation-detection outputs of the other electrodes, which are positioned between the first and second directions and are adjacent to the independent electrode, are calculated using the detection outputs that are obtained from electrodes adjacent to the first and second directions.

6. The capacitive input device according to claim 5,
wherein the interpolation-detection outputs are calculated using the detection outputs by a linear interpolation method.

7. The capacitive input device according to claim 1,
wherein wiring layers, which are connected to the respective independent electrodes, are disposed below the independent electrodes through an insulating layer.
